(19) United States
(12) Patent Application Publication
(10) Pub. No.: US 2022/0159506 A1
(43) Pub. Date: May 19, 2022

(54) Communication Node and Method Performed Therein for Handling Communication Using Different BSR Formats

(71) Applicant: Telefonaktiebolaget LM Ericsson (publ), Stockholm (SE)

(72) Inventors: Jinhua Liu, Beijing (CN); Jose Luis Pradas, Stockholm (SE)

(21) Appl. No.: 17/439,510

(22) PCT Filed: Mar. 18, 2020
(86) PCT No.: PCT/SE2020/050283

§ 371 Date: Sep. 15, 2021

(30) Foreign Application Priority Data
Mar. 21, 2019 (CN) PCT/CN2019/079018

(51) Int. Cl. H04W 28/02; H04W 72/12

(52) U.S. Cl. CPC H04W 28/0278; H04W 72/1205

(57) ABSTRACT

Embodiments herein relate e.g. to a method performed by a communication node for handling communication in a wireless communication network (100). The communication node selects a format of reporting buffer status report, BSR, from a 5 first BSR format and a second BSR format, wherein the first BSR format is associated with expected bits to transmit.

### TECHNICAL FIELD

Embodiments herein relate to a communication node and a method performed therein regarding wireless communication. Furthermore, a computer program product and a computer readable storage medium are also provided herein. In particular, embodiments herein relate to handling communication, such as handle data packets and/or controlling/managing data packet communication, in a wireless communications network.

### BACKGROUND

In a typical wireless communications network, user equipment (UE), also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node e.g. a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 4G and 5G networks such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

3GPP is studying potential solutions for efficient operation of integrated access and wireless access backhaul (IAB) in NR, i.e. using relay nodes to enhance performance of the wireless communication network.

In integrated access and wireless access backhaul, or integrated access backhaul (IAB) for short, there are two kinds of network nodes that are identified as components of a RAN. First, a radio network node denoted as an IAB-node, which is a RAN node that supports wireless access to UEs and wirelessly backhauls the access traffic. Furthermore a central network node denoted as an IAB-donor, which is a RAN node which provides UE's interface to core network and wireless backhauling functionality to IAB nodes.

An IAB node strives to reuse existing functions and interfaces defined for access. In particular, Mobile-Termination (MT), gNB-Distributed Unit (DU), gNB-Central Unit (CU), User Plane Function (UPF), Access and Mobility Management Function (AMF) and Session Management Function (SMF) as well as the corresponding interfaces NR Uu, between MT and gNB, F1, NG, X2 and N4 are used as baseline for the IAB architectures. Modifications or enhancements to these functions and interfaces for the support of IAB will be explained in the context of the architecture discussion. Additional functionality, such as multi-hop forwarding i.e. using multiple IAB nodes and intermediate nodes before reaching the IAB-donor, is included in the architecture discussion as it is necessary for the understanding of IAB operation and since certain aspects may require standardization.

The Mobile-Termination (MT) function has been defined as a component of the Mobile Equipment. In the context of this study, MT is referred to as a function residing on an IAB-node that terminates the radio interface layers of a backhaul Uu interface toward the IAB-donor or other IAB-nodes.

FIG. 1 shows a reference diagram for IAB in standalone mode, which contains one IAB-donor and multiple IAB-nodes. The IAB-donor may be treated as a single logical node that comprises a set of functions such as gNB-DU, gNB-CU-control plane (CP), gNB-CU-user plane (UP) and potentially other functions. In a deployment, the IAB-donor may be split according to these functions, which may all be either collocated or non-collocated as allowed by 3GPP NG-RAN architecture. IAB-related aspects may arise when such split is exercised. Also, some of the functions presently associated with the IAB-donor may eventually be moved outside of the IAB-donor in case it becomes evident that they do not perform IAB-specific tasks. FIG. 1 is a reference diagram for IAB-architectures, TR 38.874 v.0.7.0.

Increased latency due to multiple hops in an IAB network may adversely impact the performance of both control plane procedures, such as handover and radio link recovery, and also user plane data transmission. In order to achieve hop agnostic performance in IAB scheduling, it is important to reduce the end to end (E2E) delay from the UE to the IAB-donor, and meet the latency requirement, regardless of how many hops the UE is away from the IAB-donor.

In multi-hop networks, upstream data arriving from a child node may suffer scheduling delays at the parent node and intermediate nodes. To some extent, this is no different from a single-hop UE where new data arrives into UE buffers after a buffer status report (BSR) is sent. However, in a multi-hop network, the delays are likely to accumulate due to number of hops and aggregated volume of data at IAB-nodes and may require mitigation mechanisms. Request of uplink resources at each hop and UL data transmission are shown in FIG. 2. FIG. 2 shows Uplink Delays in IAB Network: worst case scenario, where none of the intermediate nodes have any UL resources allocated to them.

It is clear that this process can be significantly longer than the corresponding process in one-hop networks, due to the multiple consecutive uplink resource request and allocation steps. The underlying reason for these delays is that the MT part of an IAB-node can only request uplink resources for the UL data transmission after it actually receives the data to be transmitted.

One approach to mitigate such delays consists of initiating an uplink resource request at an IAB-node based on data that is expected to arrive. This would enable the IAB-node to obtain the uplink resource prior to actual data reception from its child IAB-node or a UE that it serves.

Currently, there are multiple options with respect to early BSR triggering. There are two major triggering options: one is to trigger early BSR based on the expected available bits when the UL grant is to be received after a scheduling request (SR) is transmitted in response to the early BSR, the other option is to generate SR based on the incoming BSR from e.g. a child IAB node, i.e. a IAB node downstream of a data path. With early BSR, the SR can be transmitted before the data arrival and UL grants with desired capacities can be expected to the received for the data expected to be received. The early BSR may also be referred to as pre-warning BSR.

### SUMMARY

Existing basic concept of early BSR triggering seems promising for uplink latency reduction to the SR and/or BSR procedure according Rel-15 SR and/or BSR procedure. However, Rel-15 BSR is still regarded as a baseline. Under such condition, the interaction between Rel-15 SR and/or BSR and early BSR should be addressed.

An object herein is to provide a mechanism to enable communication, e.g. handle or manage data packets, in an efficient manner in a wireless communications network.

According to an aspect the object is achieved, according to embodiments herein, by providing a method performed by a communication node, such as a relay node also denoted as IAB node, for handling data packets or handling communication in a wireless communications network. The communication node selects a format of reporting a buffer status report from a first BSR format and a second BSR format, wherein the first BSR format is associated with expected bits to transmit. The first BSR format may be an early BSR reporting the expected bits. The second BSR format may be a Rel-15 BSR format which means a regular BSR, a periodic BSR or a padding BSR as defined in release 15.

According to another aspect of embodiments herein, the object is achieved by providing a communication node, such as a relay node also denoted as IAB node, for handling data packets or handling communication in a wireless communications network. The communication node is configured to select a format of reporting a BSR, from a first BSR format and a second BSR format, wherein the first BSR format is associated with expected bits to transmit, e.g. decide to trigger an initiation of transmitting the BSR of the first BSR format or the second BSR format.

It is furthermore provided herein a computer program product comprising instructions, which, when executed on at least one processor, cause the at least one processor to carry out the method above, as performed by the communication node. It is additionally provided herein a computer-readable storage medium, having stored thereon a computer program product comprising instructions which, when executed on at least one processor, cause the at least one processor to carry out the method according to the method above, as performed by the communication node.

An advantage of embodiments herein is to provide an efficient solution to perform BSR in a flexible manner by deciding to use a first BSR format such as an early BSR format in some cases and not in some cases. Thus, embodiments herein provide e.g. an early BSR enhancement considering the interaction with Rel-15 BSR. Advantages of embodiments herein include e.g.:
Prioritization of early BSR and/or Rel-15 BSR.
Content of early BSR and early BSR format.
Early BSR cancellation.

Thus, embodiments herein e.g. resolve interaction between e.g. early BSR and Rel-15 BSR. Thus, enabling communication, e.g. handle or manage data packets, in an efficient manner in the wireless communications network such as in an IAB network.

### BRIEF DESCRIPTION OF THE DRAWINGS

Embodiments will now be described in more detail in relation to the enclosed drawings, in which:

FIG. 1 is a reference diagram depicting IAB in standalone mode;

FIG. 2 shows Uplink Delays in IAB Network;

FIG. 3 is a schematic overview depicting a wireless communications network according to embodiments herein;

FIG. 4 is a combined signalling scheme and flowchart according to some embodiments herein.

FIG. 5 is a schematic flowchart depicting a method performed by a communication node according to embodiments herein;

FIG. 6 is a block diagram depicting a communication node according to embodiments herein;

FIG. 7 is a telecommunication network connected via an intermediate network to a host computer in accordance with some embodiments;

FIG. 8 is a host computer communicating via a base station with a user equipment over a partially wireless connection in accordance with some embodiments;

FIG. 9 shows methods implemented in a communication system including a host computer, a base station and a user equipment in accordance with some embodiments;

FIG. 10 shows methods implemented in a communication system including a host computer, a base station and a user equipment in accordance with some embodiments;

FIG. 11 shows methods implemented in a communication system including a host computer, a base station and a user equipment in accordance with some embodiments; and

FIG. 12 shows methods implemented in a communication system including a host computer, a base station and a user equipment in accordance with some embodiments.

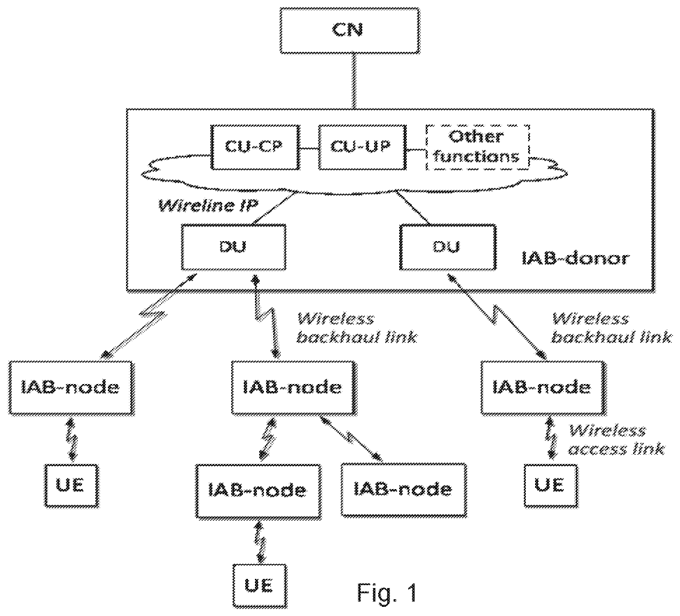

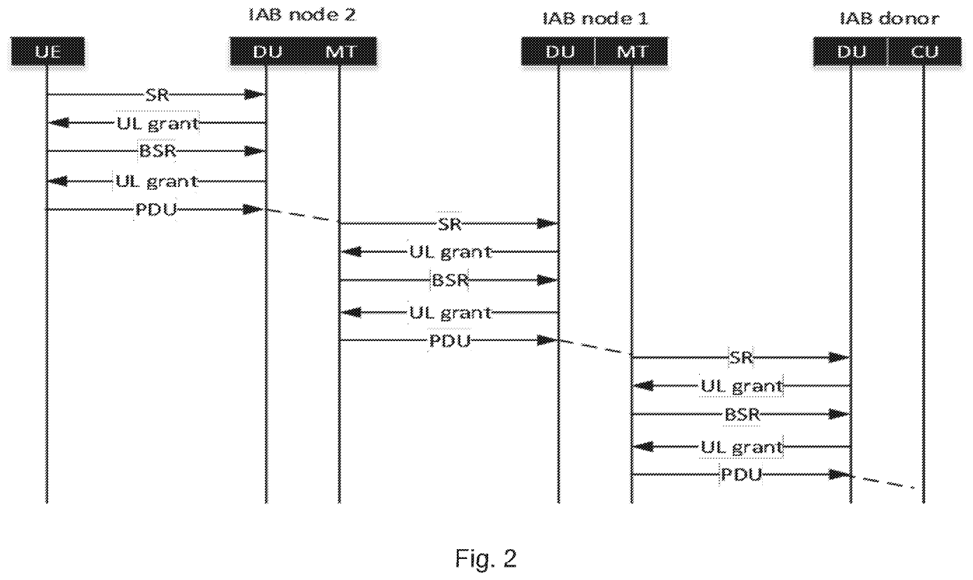

### DETAILED DESCRIPTION

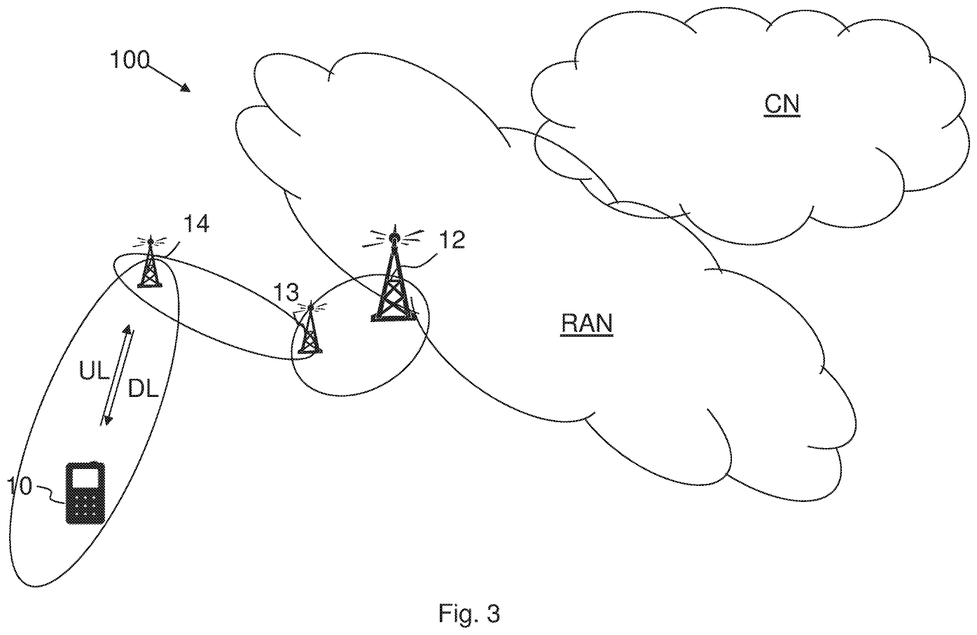

Embodiments herein relate to wireless communications networks in general. FIG. 3 is a schematic overview depicting a wireless communications network 100. The wireless communications network 100 comprises one or more RANs and one or more CNs. The wireless communications network 100 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 100, a wireless device 10 such as a mobile station, a non-access point (non-AP) STA, a STA, a user equipment (UE) and/or a wireless terminal, is comprised communicating via e.g. one or more Access Networks (AN), e.g. RAN, to one or more core networks (CN). It should be understood by the skilled in the art that “wireless device” is a non-limiting term which means any terminal, wireless communications terminal, user equipment, NB-IoT device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 100 comprises a network node 12 such as a IAB-donor node e.g. baseband unit (BBU) such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a stand-alone access point or any other network unit or node capable of communicating with a wireless device within the area served by the radio network node depending e.g. on a first radio access technology and terminology used. It should be noted that a service area may be denoted as cell, beam, beam group or similar to define an area of radio coverage.

The wireless communication network 100 further comprises a first radio network node 13 connected e.g. in-between the network node 12 and the wireless device 10. The first radio network node 13 may be an IAB node e.g. a radio remote unit (RRU) such as an access node, antenna unit, radio unit of e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on a first radio access technology and terminology used. It should be noted that a service area may be denoted as cell, beam, beam group or similar to define an area of radio coverage.

The wireless communication network 100 further comprises a second radio network node 14 connected in-between the network node 12, i.e. an intermediate node, and the wireless device 10. The second radio network node 14 may be connected to the wireless device 10 directly and may be an egress point. The second radio network node 14 may be an IAB node e.g. a radio remote unit (RRU) such as an access node, antenna unit, radio unit of e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on a first radio access technology and terminology used. It should be noted that a service area may be denoted as cell, beam, beam group or similar to define an area of radio coverage.

Embodiments herein relate to a communication node 60 which may be exemplified as any of the radio network nodes such as the first radio network node 13 and second radio network node 14, the network node 12, and the wireless device 10 transmitting a BSR being either associated with expected bits to transmit or a Rel-15 BSR format e.g. actual bits to transmit. Thus, providing a flexible solution for reporting BS from the communication node.

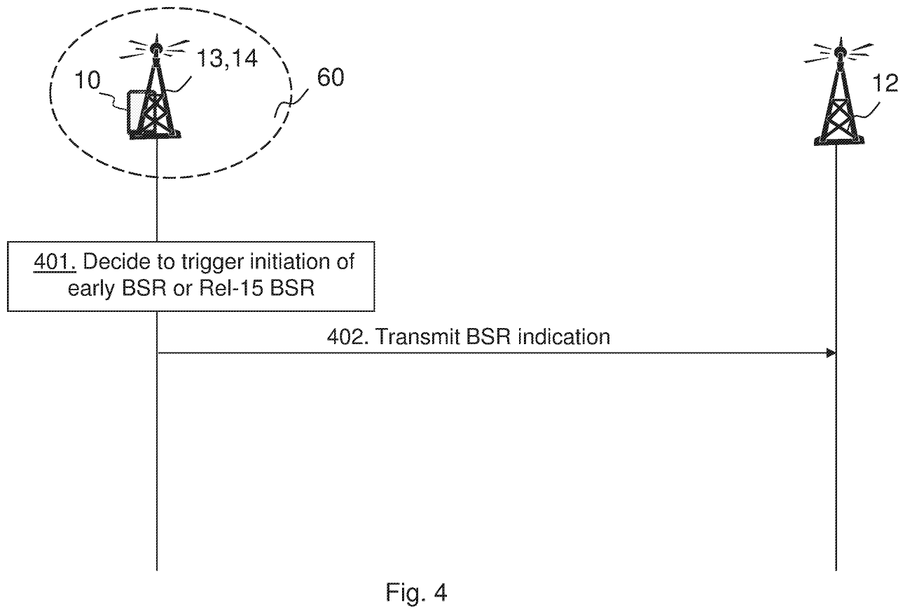

FIG. 4 is a combined signalling scheme and flowchart according to some embodiments herein. The wireless communications network may comprise a first radio network node relaying data packets between a network node and a wireless device.

Action 401. The communication node e.g. the first radio network node 13 such as an IAB node, an intermediate IAB node or a relay node, determines or decides to trigger initiation of a first BSR format, such as of early BSR, or initiation of a second BSR format, such as a Rel-15 BSR.

In a first embodiment, only one BSR format such as a buffer status report medium access control-control element (BSR MAC CE) is allowed to be transmitted in a MAC protocol data unit (PDU) e.g. the first BSR format such as the early BSR or the second format such as the Rel-15 BSR format. The early BSR reports the expected bits and Rel-15 BSR means regular BSR or periodic BSR according to standard release 15.

Different methods may be used to decide which of the two BSR formats is used when transmitting the BSR:
Prioritizing one out of at least two BSR formats. E.g. Rel-15 BSR, or early BSR, is always prioritized: When both early BSR and Rel-15 BSR are triggered, e.g. expected bits or actual bits belonging to a logical channel, e.g. with a higher priority than data already existed in a transmission buffer, arrives at the transmission buffer, and SR is transmitted, Rel-15 BSR, or early BSR, is always prioritized to be transmitted, which means early BSR, or Rel-15 BSR, is cancelled.
Early BSR and Rel-15 BSR are prioritized according to the priority of the logical channel groups (LCG) whose buffer statuses are to be reported. A priority of an LCG depends on the logical channel (LCH) of the highest priority within the LCG. The priority of early BSR, or Rel-15 BSR, depends thus on the LCG of highest priority among the LCGs whose buffer statuses are to be reported. In such way, if early BSR is higher prioritized, early BSR is transmitted while Rel-15 BSR is cancelled, otherwise, Rel-15 BSR is transmitted while early BSR is cancelled.
It can be configured via radio resource control (RRC) signaling on which one of Rel-15 and early BSRs are prioritized when both are triggered before SR transmission, which means the other BSR format is cancelled.
Early BSR is always prioritized over Rel-15 padding BSR.

In a second embodiment, any one of the following options is adopted to report BSR:
No matter whether the SR transmission is triggered according to early BSR procedure or Rel-15 BSR procedure, only Rel-15 BSR, e.g. use Rel-15 BSR MAC CE and indicate only actual buffered bits is generated and reported using the received UL grant.
If an early BSR is triggered but all or certain ratio of the expected bits reach the buffer between the triggered SR transmission and the time when the UL grant in response is received, Rel-15 BSR is transmitted, otherwise early BSR is transmitted using a new BSR MAC CE (see the fourth embodiment).
If the SR transmission is in response to an early BSR triggering, the early BSR is generated and reported based on the expected available bits per LCG, while the number of expected bits is determined according to a preconfigured time window per MAC entity or per LCH (or LCG), i.e. the number of bits to be received within the window.

In a third embodiment, similar as regular BSR in Rel-15, a timer for the delay of receiving a SR such as the logicalChannelSR-DelayTimer, if configured by upper layers, may be started or restarted upon early BSR triggering.

In a fourth embodiment, a BSR indication such as an BSR MAC CE may be generated for early BSR according to one of the following:
Single buffer status (BS) value per LCG, wherein the BS value indicates (merely) an expected number of bits to be received within a time window, wherein the time window may be per LCG or per MAC entity;
Dual BS values per LCG with a new BSR format such as a new BSR MAC CE format, wherein one BS value is a number of buffered bits and the other BS value is the expected number of bits to be received within a time window;
Dual BS values per LCG with a new BSR format such as a new BSR MAC CE format, wherein one BS value is the number of buffered bits and the other BS value is the total of the number of buffered bits and the expected number of bits to be received within a time window;

In a fifth embodiment, logicalChannelSR-Mask configured for an LCH applies for SR triggering according to early BSR as well.

In a sixth embodiment, the early BSR format such as a BSR MAC CE, if generated, has the same priority as Rel-15 regular BSR MAC CE for radio resource allocation during MAC PDU construction.

In a seventh embodiment, the early BSR enabler can be configured per MAC entity or per LCG.

Early BSR format is based on the expected available bits when the UL grant is to be received after the SR is transmitted in response to the early BSR. Early BSR is based on received BSR from another radio network node (a previous IAB node) or a wireless device. For example, a first received BSR informs the radio network node how much data is waiting for transmission at the wireless device 10 or a previous radio network node, and the radio network node 12 generates a second BSR based on that information. The early BSR may be based on an UL grant for a received BSR from another radio network node or the wireless device 10.

Buffer Status Reporting format in Rel-15 is e.g. defined as:

“The Buffer Status reporting (BSR) procedure is used to provide the serving gNB with information about UL data volume in the MAC entity.

RRC configures the following parameters to control the BSR:
periodicBSR-Timer;
retxBSR-Timer;
logicalChannelSR-DelayTimerApplied;
logicalChannelSR-DelayTimer;
logicalChannelSR-Mask;
logicalChannelGroup.

Each logical channel may be allocated to an LCG using the logicalChannelGroup. The maximum number of LCGs is eight.

The MAC entity determines the amount of UL data available for a logical channel according to the data volume calculation procedure in TSs 38.322 and 38.323 [3] [4].

A BSR shall be triggered if any of the following events occur:
the MAC entity has new UL data available for a logical channel which belongs to an LCG; and either
the new UL data belongs to a logical channel with higher priority than the priority of any logical channel containing available UL data which belong to any LCG; or
none of the logical channels which belong to an LCG contains any available UL data.

in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.

A MAC PDU shall contain at most one BSR MAC CE, even when multiple events have triggered a BSR. The Regular BSR and the Periodic BSR shall have precedence over the padding BSR.

The MAC entity shall restart retxBSR-Timer upon reception of a grant for transmission of new data on any UL-SCH.

All triggered BSRs may be cancelled when the UL grant(s) can accommodate all pending data available for transmission but is not sufficient to additionally accommodate the BSR MAC CE plus its subheader. All BSRs triggered prior to MAC PDU assembly shall be cancelled when a MAC PDU which includes a BSR MAC CE is transmitted.”

Action 402. The communication node transmits, to e.g. the network node 12 or another radio network node, the BSR indication according to the format as selected, such as a BSR MAC CE according to a format as decided above.

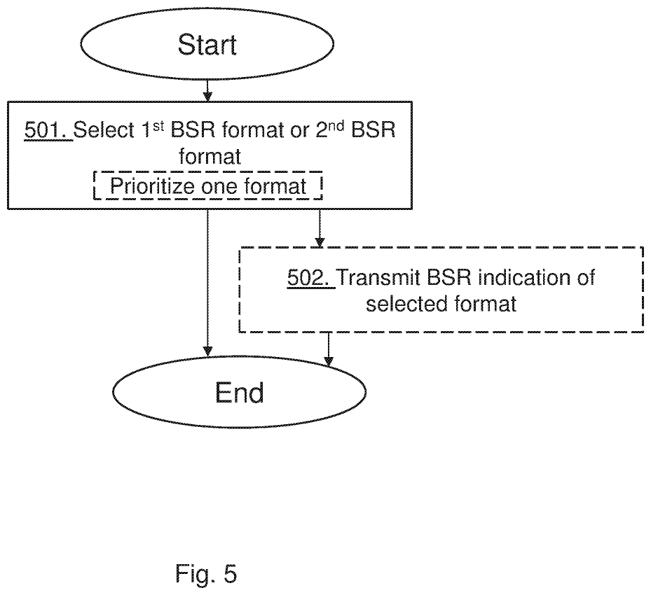

The method actions performed by the communication node 60 for handling data packets or handling communication in a wireless communications network 100 according to embodiments herein will now be described with reference to a flowchart depicted in FIG. 5. The wireless communications network 100 may comprise one or more communication nodes relaying data packets between the network node 12 and the wireless device 10. The actions do not have to be taken in the order stated below, but may be taken in any suitable order. Optional actions are marked as dashed boxes.

Action 501. The communication node 60 selects the format of reporting a buffer status report from the first BSR format and the second BSR format, wherein the first BSR format is associated with expected bits to transmit. The first BSR format may be an early BSR reporting the expected bits. The second BSR format may be an Release-15 BSR format which means a regular BSR, a periodic BSR or a padding BSR as defined in release 15. The communication node 60 may prioritize the first BSR format over the second BSR format or vice versa. The first BSR format may comprise: a single buffer status (BS) value per logical channel group (LCG), wherein the BS value indicates an expected number of bits to be received within a time window, and wherein the time window may be per LCG or per MAC entity; dual BS values per LCG, wherein one BS value is a number of buffered bits and another BS value is the expected number of bits to be received within a time window; or dual BS values per LCG, wherein one BS value is the number of buffered bits and another BS value is the total of the number of buffered bits and the expected number of bits to be received within a time window. The selection of the BSR format may be based on received scheduling request from another network node and/or data available for transmission. The communication node may thus e.g.: no matter the SR transmission is triggered according to early BSR procedure or Rel-15 BSR procedure, only Rel-15 BSR, i.e. use Rel-15 BSR MAC CE and indicate only actual buffered bits, is generated and reported using the received UL grant; if an early BSR is triggered but all or certain ratio of the expected bits reach the buffer between the triggered SR transmission and the time when the UL grant in response is received, Rel-15 BSR is transmitted, otherwise early BSR is transmitted using a new BSR MAC CE; and/or if the SR transmission is in response to an early BSR triggering, the early BSR is generated and reported based on the expected available bits per LCG, while the number of expected bits is determined according to a preconfigured time window per MAC entity or per LCH (or LCG), i.e. the number of bits to be received within the window.

Action 502. The communication node 60 may transmit, to the network node 12 or another radio network node, a BSR indication such as an early BSR or a Rel-15 BSR according to the format selected.

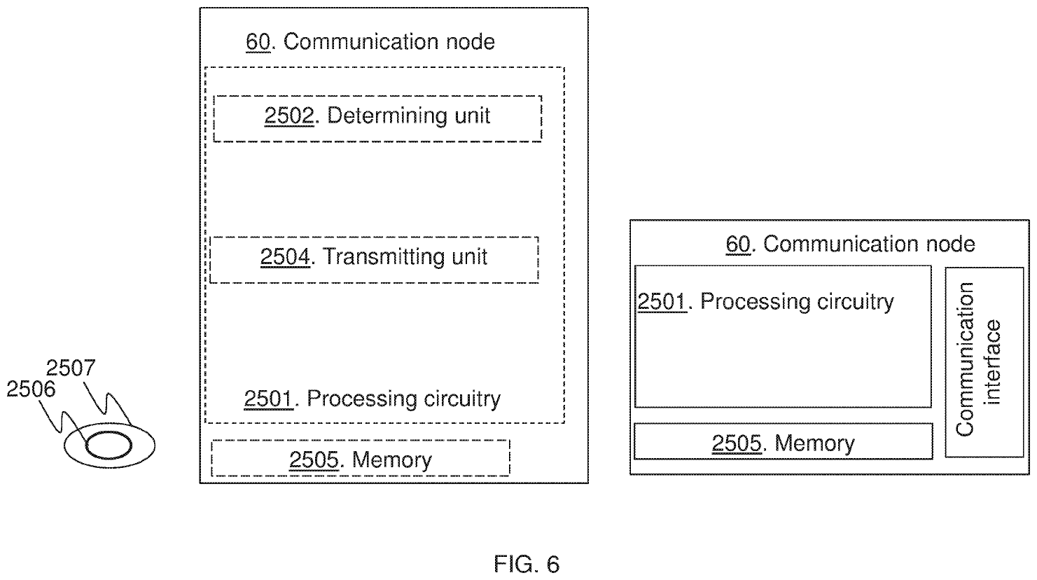

FIG. 6 is a block diagram depicting the communication node 60, such as a relay node also denoted as an IAB node or the wireless device 10, for handling data packets or handling communication in the wireless communications network 100 according to embodiments herein.

The communication node 60 may comprise processing circuitry 2501, e.g. one or more processors, configured to perform the methods herein.

The communication node 60 may comprise a determining unit 2502. The communication node 60, the processing circuitry 2501, and/or the determining unit 2502 is configured to select or determine BSR format to use. The communication node 60, the processing circuitry 2501, and/or the determining unit 2502 may e.g. be configured to select the format of reporting the buffer status report from the first BSR format and the second BSR format, wherein the first BSR format is associated with expected bits to transmit. The first BSR format may be an early BSR reporting the expected bits. The second BSR format may be an Rel-15 BSR format which means a regular BSR, a periodic BSR or a padding BSR as defined in release 15. The communication node 60, the processing circuitry 2501, and/or the determining unit 2502 may be configured to prioritize the first BSR format over the second BSR format or vice versa, i.e. configured to prioritize the second BSR format over the first BSR format. The first BSR format may comprise: a single buffer status (BS) value per logical channel group (LCG), wherein the BS value indicates an expected number of bits to be received within a time window, and wherein the time window may be per LCG or per MAC entity; dual BS values per LCG, wherein one BS value is a number of buffered bits and another BS value is the expected number of bits to be received within a time window; or dual BS values per LCG, wherein one BS value is the number of buffered bits and another BS value is the total of the number of buffered bits and the expected number of bits to be received within a time window. The selection of the BSR format may be based on received scheduling request from another network node and/or data available for transmission, e.g. amount of data for UL transmission.

The communication node 60 may comprise a transmitting unit 2504. The communication node 60, the processing circuitry 2501, and/or the transmitting unit 2504 may be configured to transmit to another radio network node and/or the network node 12, the BSR indication according to the format as selected i.e. as the selected format such as a BSR of a first BSR format or a second BSR format indicating BS at the communication node 60.

The communication node 60 further comprises a memory 2505. The memory 2505 comprises one or more units to be used to store data on, such as data packets, events for triggering BSR reports of different formats, and applications to perform the methods disclosed herein when being executed, and similar. Furthermore, the communication node 60 may comprise a communication interface such as comprising a transmitter, a receiver, a transceiver and/or one or more antennas.

The methods according to the embodiments described herein for the communication node 60 are respectively implemented by means of e.g. a computer program product 2506 or a computer program, comprising instructions, i.e., software code portions, which, when executed on at least one processor, cause the at least one processor to carry out the actions described herein, as performed by the communication node 60. The computer program product 2506 may be stored on a computer-readable storage medium 2507, e.g. a disc, a universal serial bus (USB) stick or similar. The computer-readable storage medium 2507, having stored thereon the computer program product, may comprise the instructions which, when executed on at least one processor, cause the at least one processor to carry out the actions described herein, as performed by the communication node 60. In some embodiments, the computer-readable storage medium may be a transitory or a non-transitory computer-readable storage medium. Thus, embodiments herein may disclose a communication node for handling communication in a wireless communications network, wherein the communication node comprises processing circuitry and a memory, said memory comprising instructions executable by said processing circuitry whereby said communication node is operative to to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

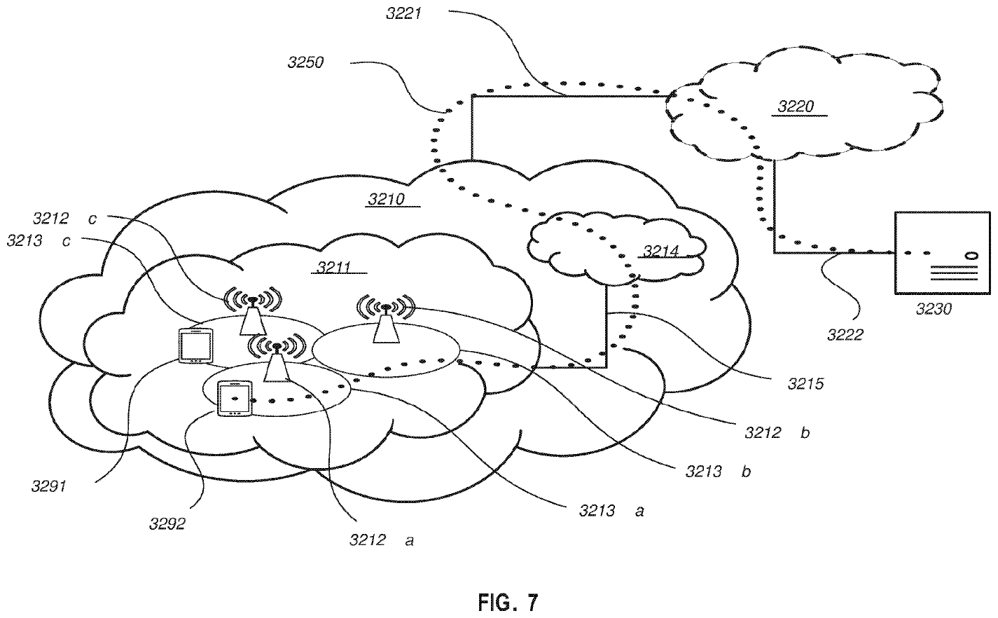

FIG. 7 shows a Telecommunication network connected via an intermediate network to a host computer in accordance with some embodiments. With reference to FIG. 7, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the wireless device 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 7 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

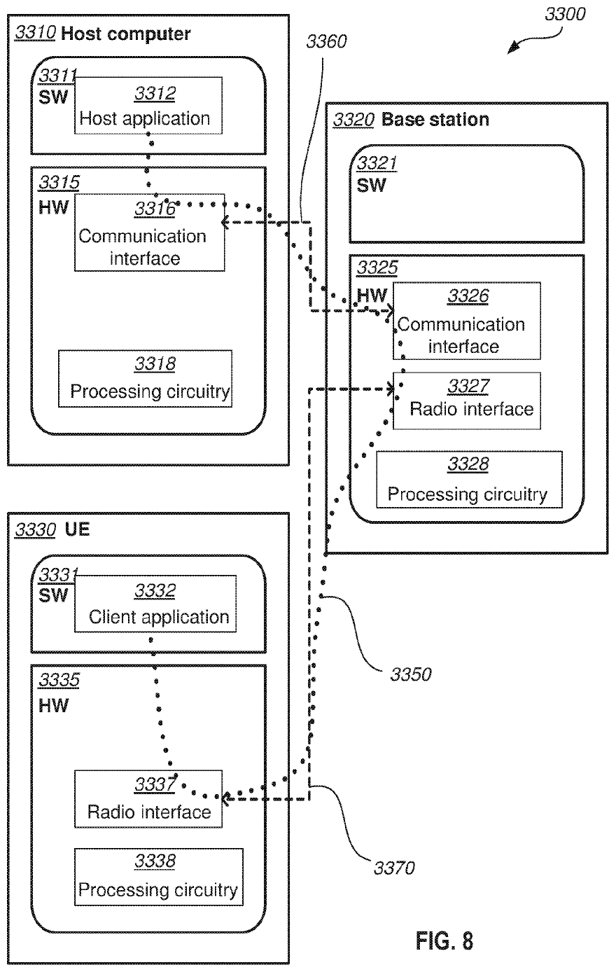

FIG. 8 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 8. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 8) served by base station 3320. Communication interface 3326 may be configured to facilitate connection 3360 to host computer 3310. Connection 3360 may be direct or it may pass through a core network (not shown in FIG. 8) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 8 may be similar or identical to host computer 3230, one of base stations 3212a, 3212b, 3212c and one of UEs 3291, 3292 of FIG. 7, respectively. This is to say, the inner workings of these entities may be as shown in FIG. 8 and independently, the surrounding network topology may be that of FIG. 7.

In FIG. 8, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments make it possible to handle BSR in a more flexible manner. Thereby the data communication, e.g. the handling or managing of data packets may be performed in an efficient manner and thereby provide benefits such as reduced waiting time and better responsiveness for a wireless device.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and itmay be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

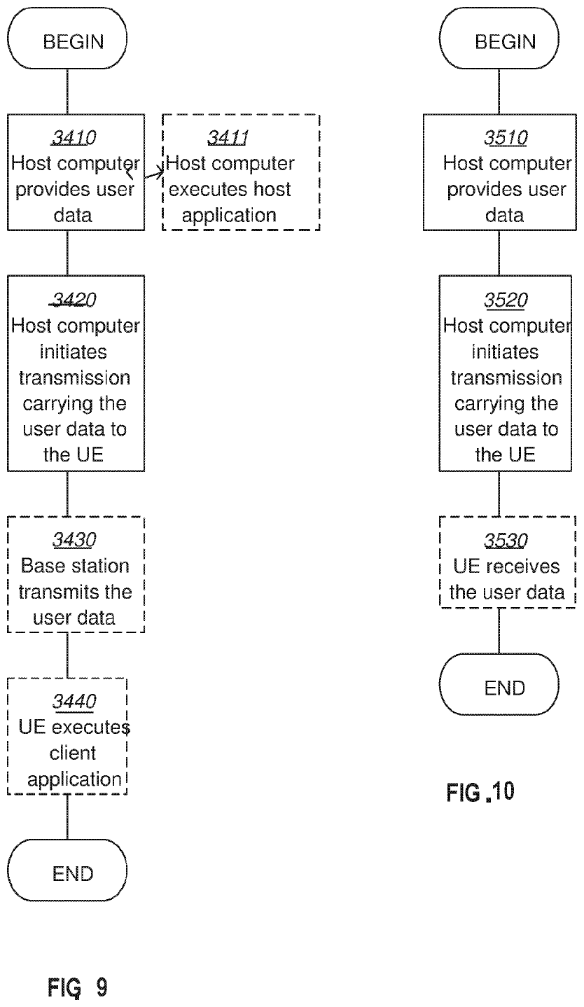

FIG. 9 shows methods implemented in a communication system including a host computer, a base station and a user equipment in accordance with some embodiments.

FIG. 9 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 9 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 10 shows methods implemented in a communication system including a host computer, a base station and a user equipment in accordance with some embodiments.

FIG. 10 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 10 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

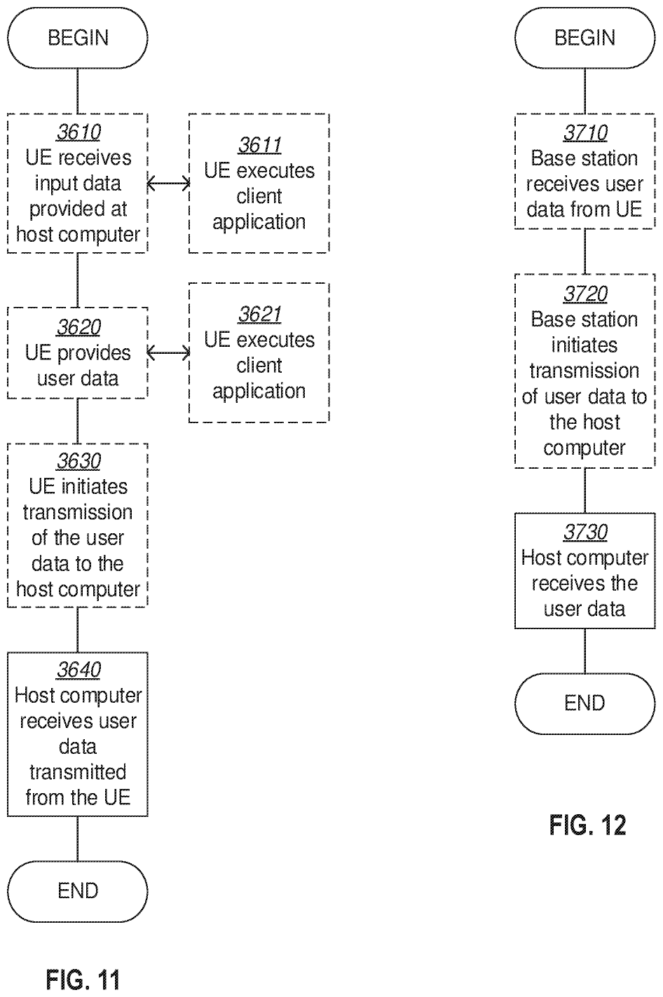

FIG. 11 shows methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 11 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 12 show methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 12 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| Abbreviation | Explanation |
|---|---|
| 3GPP | 3rd Generation Partnership Project |
| IAB | Integrated Access Backhaul |
| CN | Core Network |
| CU | Central Unit |
| DU | Distributed Unit |
| CP | Control Plane |
| UP | User Plane |
| UE | User Equipment |
| PDCP | Packet Data Convergence Protocol |
| RLC | Radio Link Control |
| MAC | Medium Access Control |
| SDU | Service Data Unit |
| PDU | Protocol Data Unit |
| SR | Scheduling Request |
| BSR | Buffer Status Report |
| UL | Uplink |
| DL | Downlink |
| ACK | Acknowledgement |
| NACK | Negative ACK |
| RRC | Radio Resource Control |
| SIB | System Information Block |

1-16. (canceled)

17. A method performed by a communication node for handling communication in a wireless communication network, the method comprising:
selecting a format of reporting a buffer status report (BSR) from a first BSR format and a second BSR format, wherein the first BSR format is associated with expected bits to transmit.

18. The method of claim 17, wherein the first BSR format is an early BSR reporting the expected bits, and the second BSR format is an Release-15 BSR format.

19. The method of claim 17, wherein the second BSR format comprises a regular BSR, a periodic BSR, or a padding BSR as defined in Release 15.

20. The method of claim 17, wherein the communication node prioritizes the first BSR format over the second BSR format, or vice versa.

21. The method of claim 17, further comprising transmitting, to a network node or another radio network node, an BSR indication according to the format as selected.

22. The method of claim 17, wherein the first BSR format comprises:
a single buffer status (BS) value per logical channel group (LCG); wherein the BS value indicates an expected number of bits to be received within a time window; wherein the time window is per LCG or per medium access control (MAC) entity;
dual BS values per LCG, wherein one BS value is a number of buffered bits and another BS value is the expected number of bits to be received within a time window; or
dual BS values per LCG, wherein one BS value is the number of buffered bits and another BS value is the total of the number of buffered bits and the expected number of bits to be received within a time window.

23. The method of claim 17, wherein selection of the BSR format is based on received scheduling request from another network node and/or data available for transmission.

24. A communication node for handling communication in a wireless communication network, the communication node comprising:
processing circuitry;
memory containing instructions executable by the processing circuitry whereby the communication node is operative to:
select a format of reporting a buffer status report (BSR) from a first BSR format and a second BSR format, wherein the first BSR format is associated with expected bits to transmit.

25. The communication node of claim 24, wherein the first BSR format is an early BSR reporting the expected bits, and the second BSR format is an Release-15 BSR format.

26. The communication node of claim 24, wherein the second BSR format comprises a regular BSR, a periodic BSR, or a padding BSR as defined in Release 15.

27. The communication node of claim 24, wherein the instructions are such that the communication node is operative to prioritize the first BSR format over the second BSR format, or vice versa.

28. The communication node of claim 24, wherein the instructions are such that the communication node is operative to transmit, to the network node or another radio network node, an BSR indication according to the selected format.

29. The communication node of claim 24, wherein the first BSR format comprises:
a single buffer status (BS) value per logical channel group (LCG); wherein the BS value indicates an expected number of bits to be received within a time window; wherein the time window is per LCG or per medium access control (MAC) entity;
dual BS values per LCG, wherein one BS value is a number of buffered bits and another BS value is the expected number of bits to be received within a time window; or
dual BS values per LCG, wherein one BS value is the number of buffered bits and another BS value is the total of the number of buffered bits and the expected number of bits to be received within a time window.

30. The communication node of claim 24, wherein the selection of the BSR format is based on received scheduling request from another network node and/or data available for transmission.

31. A non-transitory computer readable recording medium storing a computer program product for controlling a communication node in a wireless communication network, the computer program product comprising program instructions which, when run on processing circuitry of the communication node, causes the communication node to:
select a format of reporting a buffer status report (BSR) from a first BSR format and a second BSR format, wherein the first BSR format is associated with expected bits to transmit.
